(19) United States
(12) Patent Application Publication
(10) Pub. No.: US 2026/0104796 A1
(43) Pub. Date: Apr. 16, 2026

(54) OPTIMIZED DATA COMPRESSION WITH REDUCED PADDING

(71) Applicant: Micron Technology, Inc., Boise, ID (US)

(72) Inventor: Rishabh Dubey, Agrate Brianza, MB (IT)

(21) Appl. No.: 19/306,157

(22) Filed: Aug. 21, 2025

Related U.S. Application Data
(60) Provisional application No. 63/690,005, filed on Sep. 3, 2024.

(51) Int. Cl. G06F 3/06

(52) U.S. Cl. CPC G06F 3/0608; G06F 3/0655; G06F 3/0679

(57) ABSTRACT

A method for compressing data in a memory device involves receiving write data, splitting the write data into sub-blocks based on a compression block size, and compressing each sub-block to produce compressed sub-blocks. The method includes writing the compressed sub-blocks into a write block of memory cells, where at least one compressed sub-block spans multiple sub-blocks, and adding padding only at the end of the write block. An indirection table manages the mapping of compressed sub-blocks within the write block, with entries indicating the start of each write block and the location of each compressed sub-block. The method also includes retrieving specific data blocks using the indirection table and adapting the indirection block size based on data compression entropy to optimize memory space and performance.

### PRIORITY APPLICATION

This application claims the benefit of priority to U.S. Provisional Application Ser. No. 63/690,005, filed Sep. 3, 2024, which is incorporated herein by reference in its entirety.

### TECHNICAL FIELD

Embodiments pertain to memory management systems and, in some examples, to techniques for improving compression ratios by reducing padding overhead in memory devices.

### BACKGROUND

Memory management systems are integral to the efficient operation of computing systems, particularly in environments where data storage and retrieval speed are paramount. These computing systems often employ various techniques to manage data, including compression algorithms to reduce the amount of physical storage required. Compression can help optimize storage space and improve data transfer rates, but it also introduces complexities in managing compressed and uncompressed data.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram of a compression scheme where the write block and read block sizes are the same according to some examples of the present disclosure.

FIG. 2 illustrates a diagram of a compression scheme where the read and compression block sizes are different from the write block size according to some examples of the present disclosure.

FIG. 3 illustrates a flowchart of a method for compressing data in a memory device according to some examples of the present disclosure.

FIG. 4 illustrates an example computing environment including a memory system, according to some examples of the present disclosure.

FIG. 5 illustrates a flowchart of a method for reading compressed data using an indirection table according to some examples of the present disclosure.

FIG. 6 illustrates a block diagram of an example machine upon which one or more of the techniques discussed herein may be performed according to some examples of the present disclosure.

### DETAILED DESCRIPTION

Cloud Solution Providers (CSPs) and Independent Software Vendors (ISVs) often store petabytes, exabytes, or even zettabytes of data. To reduce storage costs, these CSPs and ISVs have traditionally implemented host-side compression. In some examples, to balance the need to reduce costs with the need to maintain performance, these systems may only compress certain data. For example, less frequently accessed data (categorized as ‘cold’ data) may be compressed to save space, while data that is more frequently accessed (categorized as ‘hot’ data) may be stored without being compressed.

In some examples, the cold data and hot data may also be stored in different memory tiers. A memory tier refers to a distinct level or category within a hierarchical memory system, where each tier is characterized by different performance attributes, such as speed, latency, and cost. Memory tiers are used to optimize the storage and retrieval of data based on its access frequency and importance. Typically, memory tiers are organized in a way that balances performance and cost, with faster, more expensive memory used for frequently accessed data (hot data) and slower, more cost-effective memory used for less frequently accessed data (cold data). In some examples, the host may manage these tiers via kernel or hypervisor techniques, such that the host views the total memory as a combination of Tier 1 (uncompressed) and Tier 2 (compressed) memory while leaving the details to other components in the system.

In some examples, the compression and decompression as well as the management of the compressed memory may be offloaded to the memory device itself. By doing so, the host system is relieved of the computational burden associated with these tasks, allowing it to focus on other operations. The memory device handles the compression and management of data as it is written to the memory and decompresses it when it is accessed. This offloading not only improves the efficiency of memory management but also enhances the overall system performance by reducing the latency associated with data compression and decompression.

Once compressed, a particular unit of data is typically made smaller. This presents challenges as data received from the host is typically of a certain size that corresponds to the storage unit of a memory device (e.g., a memory block). Sometimes a next unit of data, when compressed, will also fit in that block unit and thus space is saved by packing two blocks of data into a single block. If however, the compressed next unit of data cannot fit into the block with the compressed data, padding may be used to fill the extra space in the block. This padding not only wastes space but also reduces the compression ratio-a measure of the compression efficiency. For instance, if a 64-byte block of data compresses to 40 bytes, and the next block compresses to a size greater than 24 bytes, an additional 24 bytes of padding may be needed so as to align the position of the next block to the next 64-byte boundary.

This inefficiency is exacerbated by the granularity of the compression blocks. Smaller block sizes, while potentially beneficial for reducing latency during data access, lead to poor overall compression ratios due to the frequent need for padding. In addition, smaller compression blocks tend to compress less with the dictionary-based compression schemes, such as LZ4, used in these applications. This issue is compounded even more by the necessity for larger indirection tables to manage these smaller blocks, which requires additional entries in the table for each block, which further complicates the architecture. An indirection table is used in memory management systems to keep track of the locations of compressed data blocks within a memory device.

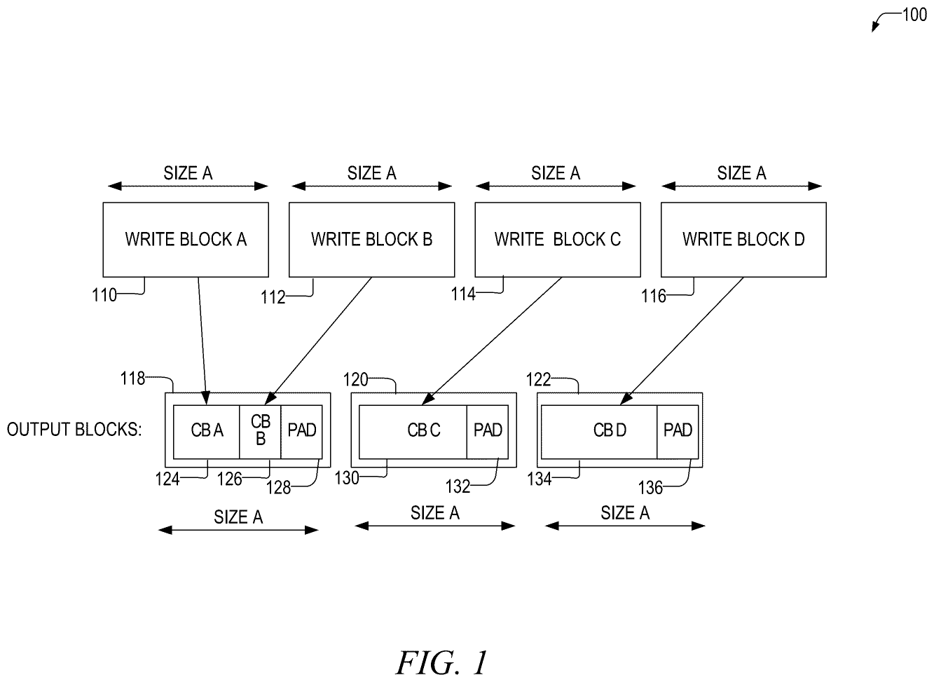

FIG. 1 illustrates a diagram of a compression scheme according to some examples of the present disclosure. In the example of FIG. 1, the write block and read block sizes are the same (e.g., 64B). Write blocks A 110, B 112, C 114, and D 116 that are of a first size (e.g., 64B) are each compressed to create compressed blocks (CB). Write block A 110 is compressed into CB A 124; write block B 112 is compressed into CB B 126; write block C 114 is compressed into CB C 130; and write block D 116 is compressed into CB D 134. These compressed sub blocks (CBs) are then written to output blocks of the same first size (64B). To take advantage of the compression, multiple consecutive compressed blocks that can fit within the same output block are stored together. Thus, CB A 124 and CB B 126 are stored in output block 118. Since CB C 130 cannot fit in the space remaining in output block 118, the rest of the space is filled with pad bits 128 and CB C 130 is stored in output block 120. Similarly, CB D 134 cannot fit in the remaining space of output block 120. Thus, the remaining space is filled with pad bits 132 and the CB D 134 is written to output block 122 and padding bits 136 are added to fill the remaining space in the output block 122. As noted, the use of pad bits reduces the efficiency of the compression.

Disclosed in some examples are methods, systems, devices, and machine-readable mediums for optimizing memory compression by independently adjusting the granularity of read, write, and indirection operations to improve the overall device compression ratio and reduce the overhead associated with padding. The proposed solution involves selecting different granularities for read and write operations based on the access patterns observed in host interactions. Specifically, while maintaining a read granularity that aligns with typical read access patterns, the write granularity is expanded to accommodate larger blocks of data. This adjustment exploits the nature of host write operations, which often involve writing larger blocks of data, particularly in cold tiers of memory.

The system breaks a write block (e.g., a 4 KB block) received from the host into a plurality of smaller compression blocks (e.g., 64B). Each compression block is then compressed, and the compressed sub-blocks are written consecutively within a larger write block (e.g., 4 KB). Padding is only added at the end of the entire write block, not at the end of each compressed sub-block. The entire write block may be subdivided into a plurality of read blocks of a smaller size than the write block that can each be independently read. A compressed sub-block may be written so as to cross a read block boundary (e.g., the compressed sub-block is partially in two or more separate read blocks). This solution significantly reduces the amount of padding needed compared to previous methods, thereby enhancing the compression ratio. Additionally, it allows for more natural access patterns (e.g., 4 KB writes but 64B reads) and simplifies the management of memory by allowing for a smaller indirection table that records information about the start of each large block and each smaller chunk inside the larger block.

As an example, a system may utilize a 64-byte read and compression block size for optimal read performance while using a 4 KB write granularity to minimize padding. By compressing data at 64-byte blocks, writing the compressed data across 64-byte read blocks, and adding padding only at the end of the entire 4 KB write block, the disclosed techniques significantly reduce padding overhead, thereby enhancing the overall compression ratio. In some examples, the write block size, read block size, and compression block size may be chosen based upon read access pattern, hit rate, and compression algorithm effectiveness. For example, some dictionary-based compression algorithms perform better with larger compression block sizes-which may indicate a need for larger read and/or compression block size. The write granularity may be chosen based upon a host write access pattern. For example, based upon the sizes typically written by a host. In some examples, the sizes may be chosen automatically by the memory system and adjusted dynamically based upon observed access patterns and effective compression ratios.

While the specification has described compression and read access granularity as being the same, in some examples, compression and read access granularity can be different. For example, if the system has a compressed block granularity as 128 KB and read accesses are done at a 64B granularity, in that case indirection table would have a base address and 32 (4K uncompressed data would have 32 128K Blocks) 12 bit offsets for each compressed block. To serve the read request, the device would calculate the associated compressed block e.g., a 5th 64B Read access, it would read the compressed block written from the 2nd offset. After decompressing the compressed block it would get 128 KB uncompressed data, and to read the 5th 64B of 4K, it would transfer first half (64B) of the 128 KB uncompressed data to host, if the read is for 6th 64B of 4K it would transfer 2nd half of 128 KB uncompressed data.

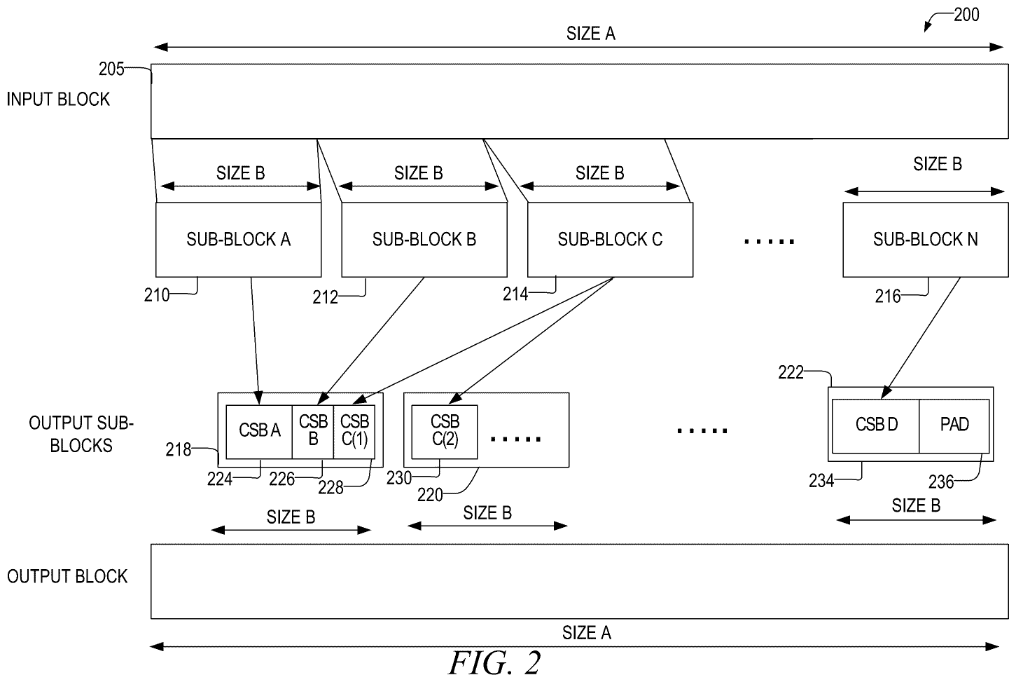

FIG. 2 illustrates a diagram of an Improved compression scheme according to some examples of the present disclosure. In contrast to FIG. 1, the scheme in FIG. 2 uses read and compression block sizes that are different from the write block sizes. For example, a compression and read size of 64B and a write block size of 4 KB. An input block 205 of a size A (e.g., 4 KB) is received from the host. The input block 205 is divided into a number of sub-blocks A 210, B 212, C 214, . . . . N 216 of a size B (e.g., 64B) based upon the compression block size. These blocks are then compressed to create compressed sub-blocks (CSBs). Input block A 210 is compressed into CSB A 224; input block B 212 is compressed into CSB B 226; input block C 214 is compressed into CSB C 230; and so on until input block N 216 is compressed into CSB D 234. In the example of FIG. 2, N is a number calculated by dividing A by B. These compressed sub blocks (CSBs) are then written to various output sub-blocks of size B within an output block of size A. The sub-blocks may be a read-block of a read block size (which may be the same size as the compression block).

To take advantage of the compression, where multiple consecutive compressed sub-blocks can fit within a same output sub-block, they are stored together. Thus, CSB A 224 and CSB B 226 are stored in output sub-block 218. Unlike FIG. 1 where CB C 130 cannot fit in the space remaining in output block 118, and the rest of the space in output block 118 was filled with pad bits 128, a first portion of CSB C 228 is written to output sub-block 218 and the remaining portion of CSB C 230 is stored in output sub-block 220. This continues until the last CSB, CSB D234 is written to the last output sub-block 222. Pad bits 236 are then added only to the end of the last output sub-block of the entire output block (e.g., 4 KB) rather than in FIG. 1 where each individual 64B sub-block had padding added when it had space that could not be filled. In some examples, if there is space in the output block, additional CSBs from a next input block after input block 205 may be written to the output block and padding only added when a next CSB from the next input block cannot fit in the remaining space.

When considering common access patterns, such as 64-byte read accesses and 4 KB write accesses, which are typical in cloud service provider environments, the compression ratio of prior art methods utilizing per sub-block padding to align compressed data blocks can be significantly reduced using the disclosed techniques. Specifically, adding padding to each sub-block may decrease the compression ratio by approximately 20-50%, depending on the specific access patterns and the size of the compression blocks. In contrast, implementing the disclosed invention, which involves compressing data at a first size (e.g., 64 Bytes) and adding padding only at the end of the entire write block (e.g., 4 KB), resulted in a much smaller decrease of the compression ratio of approximately 1-2%, which is an improvement of 19-48%.

The improved indirection table in the disclosed invention also addresses the inefficiencies associated with managing compressed data blocks in memory devices. Traditional memory management systems that employ smaller compression block sizes, such as 64-byte blocks, require a significantly larger indirection table to keep track of the locations of these compressed blocks as each 64-byte block has a separate entry in the table. This increase in the indirection table size can lead to additional overprovisioning, reducing the available storage capacity and increasing the complexity of memory management. The present disclosure provides improved indirection tables that mitigates this issue.

The new indirection table in the disclosed invention maintains an entry for each write block. The entry includes the address of the start of the write block and offsets for each read block within the write block. While the size of each entry increases over prior art indirection tables, the number of entries is significantly reduced and overall minimizes the memory overhead associated with the indirection table, while at the same time preserving the benefits of small block sizes thereby enhancing the overall storage efficiency of the memory device.

When a new write block is created, the system generates an entry in the indirection table that records a record with the starting address of the write block and an entry within the record that indicates the offsets for each compressed sub-block within the write block. During read operations, the memory system uses the indirection table to locate the specific compressed sub-blocks within the write block. The system retrieves the entry corresponding to the write block and uses the offsets to determine the exact location of the sub-block with the required data.

For example, a traditional indirection table of a 64 Byte granularity, defining each read-block may be of the form:

| 64 Byte read block | Address |
|---|---|
| 0 | 5 Byte Address |
| 1 | 5 Byte Address |
| . . . | . . . |

Each 64 Byte read block stores a 5 Byte address for that block. If the memory system manages one TB of storage (1024 GB), that means there are approximately 1.7×10¹⁰ table entries. At 64 Bytes per entry, that would consume roughly 80 GB.

In some examples, an improved table can reduce this storage requirement by having entries for each write block (e.g., each 4K block) and sub-entries for each 64 Byte read block. For example:

| 4096 write block | |
|---|---|
| 0 | 100 Byte structure |
| 1 | 100 Byte structure |
| . . . | . . . |

Each entry in the table may be of the form:

| Start of 4K | | | | | |
|---|---|---|---|---|---|
| entry (64 B | 1st 64 B | 2nd 64 B | 3rd 64 B | | 63rd 64 B |
| aligned) | block | block | block | . . . | block |
| 5 Bytes | 12 Bits | 12 Bits | 12 Bits | . . . | 12 Bits |

The start of the 4K entry is a full address, and each field is an offset off that address. For the same one TB of data, this requires approximately 25 GB of space. This is a savings of approximately 54 GB.

In some examples, the indirection table may be adaptable based on the compression entropy of the data. For data with stable compression entropy, such as cold data (e.g., data accessed less than a specified number of times within a specified time period), the indirection table can utilize larger entries. For example, a single entry may cover twice the size of a write block, further minimizing the number of entries required. This adaptability allows the indirection table to optimize memory space by using larger indirection block sizes for cold data, which is less frequently accessed and has more stable compression characteristics. By reducing the number of entries and optimizing the mapping of compressed data blocks, the new indirection table enhances the efficiency and performance of the memory management system, making it more suitable for environments with diverse and demanding data access patterns. In some examples, the memory device may determine which data is hot and which is cold, and place the data in the specified tier. In some examples, the memory device may utilize larger indirection block sizes for cold tiers. In still other examples, the indirection table may include both smaller and larger indirection blocks. The larger indirection blocks may store location data (e.g., addresses and offsets) for cold data. The memory device may adaptively change the size of the indirection blocks based upon the access patterns of the data. That is, if an item of data is accessed less than a threshold number of times, the memory device may store the item along with other data that is similarly accessed less than the threshold number of times and use larger block sizes in the indirection table to point to these locations.

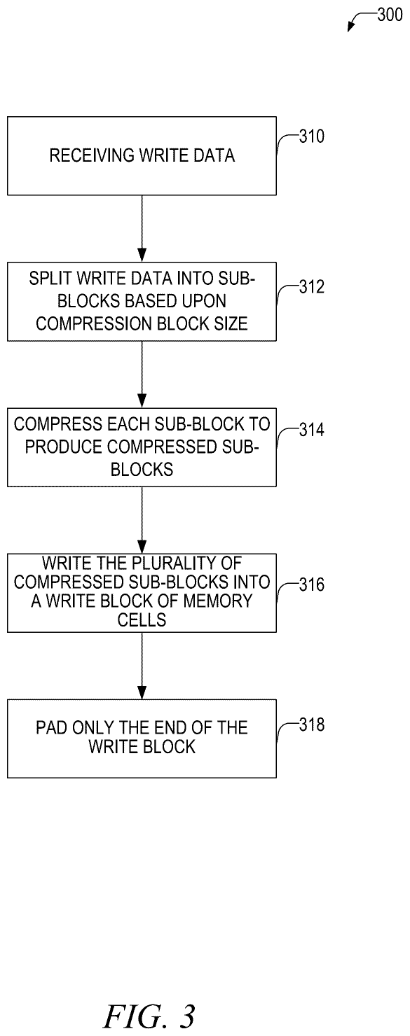

FIG. 3 shows a method 300 of memory compression according to some examples of the present disclosure. At operation 310, the method begins with receiving write data. This operation involves the initial step where the memory device obtains the data that needs to be written and subsequently compressed. The write data may be received from a host system.

At operation 312, the method proceeds to split the write data into sub-blocks based upon the compression block size. This operation involves dividing the received write data into smaller segments, each corresponding to a predefined compression block size, which facilitates the subsequent compression process. At operation 314, the method compresses each sub-block to produce compressed sub-blocks. This operation involves applying a compression algorithm to each of the sub-blocks created in the previous step, resulting in a set of compressed sub-blocks whose sizes vary based on the compressibility of the original data.

Compressibility in data compression is a measure of how much a given set of data can be compressed using a compression algorithm. The compressibility of data may be expressed as a compression ratio, which is calculated by dividing the uncompressed size by the compressed size—e.g., (Compression Ratio=Uncompressed Size/Compressed Size). For example, if a 10 MB file is compressed to 2 MB, the compression ratio would be 5:1 (or simply 5). Alternatively, compressibility can be expressed as space saving, which is the reduction in size relative to the uncompressed size: (Space Saving=1−Compressed Size/Uncompressed Size). Using the same example, the space saving would be 1−(2/10)=0.8 or 80%. The compressibility of data depends on various factors, including the data type, entropy of the data, and the compression algorithm.

At operation 316, the method writes the plurality of compressed sub-blocks into a write block of memory cells. This operation involves storing the compressed sub-blocks into a designated write block within the memory cells. The write block comprises multiple smaller sub-blocks, and the compressed sub-blocks are written across these sub-blocks. The sub-blocks may correspond to a read-block size of a designated read operation granularity.

At operation 318, the method pads only the end of the write block. This operation involves adding padding data solely at the end of the entire write block, rather than at the end of each individual sub-block. This approach minimizes the padding overhead, thereby improving the overall compression ratio.

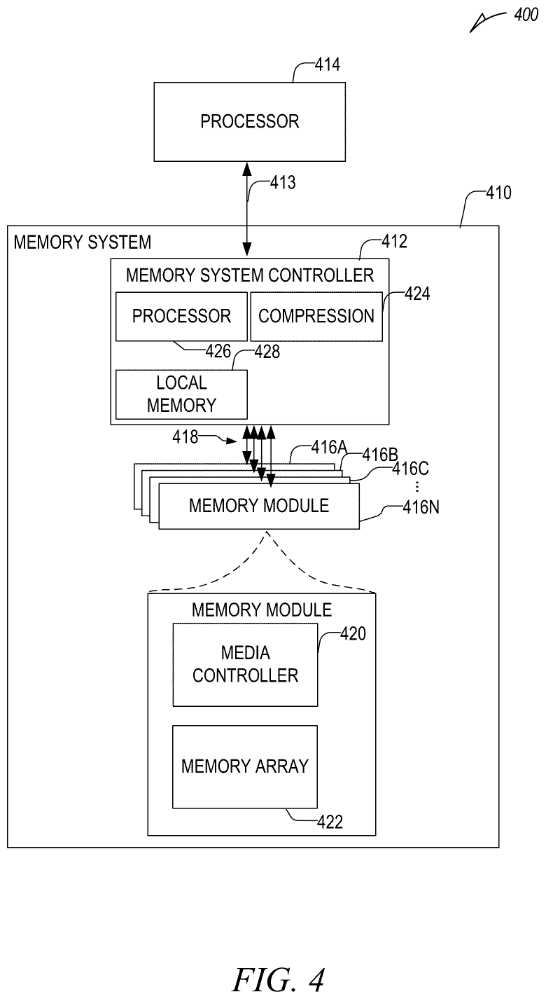

FIG. 4 illustrates an example computing environment 400 including a memory system 410, in accordance with some examples of the present disclosure. Memory system 410 can include volatile or non-volatile memory and can allow processor 414 to store and read data to and from the memory system 410. In some examples the memory system 410 can be a random-access memory (RAM) which is used by processor 414 to load and store instructions and other values. In some examples, the memory system 410 can be a non-volatile storage device such as a solid-state drive (SSD), a Universal Flash Storage (UFS) device, an embedded Multi-Media Controller (eMMC) drive, a hard disk drive (HDD), or the like.

The memory system 410 can include a memory system controller 412. The memory system controller 412 can be coupled with processor 414. Processor 414 can include one or more processor cores. In some examples, processor 414 and memory system controller 412 can be on a same die. For example, on x86-based systems, the memory controller can be on a same die as one or more processor cores of processor 414. In other examples, memory system controller 412 can be on a separate die from the processor 414. In yet other examples, the memory system controller 412 can be on a same package as the processor cores, but a separate die. Memory system controller 412 and the processor 414 can be coupled over the first interface 413.

In examples in which the memory system 410 is non-volatile storage, such as an SSD or UFS device, and in which the memory system controller 412 is not on the same die or package as the processor 414, the first interface 413 can be a Peripheral Component Interconnect-Express (PCIe) bus, a UFS bus, a serial advanced technology attachment (SATA) interface, a universal serial bus (USB) interface, a Fibre Channel, Serial Attached SCSI (SAS), an eMMC interface, or the like. In examples in which the memory system 410 is volatile RAM, and the memory system controller 412 is not on the same die or package as the processor 414, the first interface 413 can be a system bus or a front-side bus. In examples in which the memory system controller 412 is on a same die or package as the processor 414, the first interface 413 can be one or more traces, pins, or the like.

Memory modules such as modules 416A to 416N can be coupled to the memory system controller 412 over one or more internal or external second interfaces 418. In examples in which the memory system 410 is a volatile RAM system, and the memory system controller 412 is on a same die or package as the processor 414, the second interfaces 418 can be a system bus or front-side bus. In other examples, where the first interface 413 is the front-side bus or system bus, then the second interface 418 can be a memory bus. In examples in which the memory system 410 is non-volatile storage, such as a NAND device, the second interface 418 can be an internal memory bus.

The memory system 410 is shown, by way of example, to include the memory system controller 412 and media, such as memory modules 416A to 416N. The memory modules 416A to 416N can include any combination of the different types of volatile and/or non-volatile memory devices. In some examples, memory modules 416A to 416N can include random access memory (RAM), dynamic random-access memory (DRAM), such as in the form of or more Single Inline Memory Modules (SIMMS), Dual Inline Memory Modules (DIMMS) and the like; and/or as mentioned earlier herein, the memory modules can be any of various forms of stacked SDRAM die. In the case of such stacked SDRAM die, controller functionality implemented at least in part through control circuitry and related logic is often found on an associated die which in some examples, can be stacked with multiple SDRAM die. DIMMS can include control functionality, part of which can be present in a register clock driver (RCD) included on the memory module.

In some examples, memory modules 416A to 416N can include non-volatile memory devices such as not-and (NAND) flash memory. Each of the memory modules 416A to 416N can include one or more memory arrays of memory cells such as single level cells (SLCs) or multi-level cells (MLCs) (e.g., triple level cells (TLCs) or quad-level cells (QLCs)). In yet other examples, the memory modules 416A to 416N can include phase change memory (PCM), magneto random access memory (MRAM), not-or (NOR) flash memory, electrically erasable programmable read-only memory (EEPROM), and/or a cross-point array of non-volatile memory cells. A cross-point array of non-volatile memory can perform bit storage based on a change of bulk resistance, in conjunction with a stackable cross-gridded data access array. Additionally, in contrast to many Flash-based memory, cross point non-volatile memory can perform a write in-place operation, where a non-volatile memory cell can be programmed without the non-volatile memory cell being previously erased.

Each of the memory cells of the memory array 422 can store bits of data (e.g., data blocks) used by the processor 414 or another component of a host system. Memory modules 416A-416N can include a separate media controller 420, a memory array 422, and other components. In some examples, the memory modules 416A-N can not include a media controller 420. Furthermore, the memory array 422 of the memory modules 416A-N can be grouped in one or more logical organizations. For volatile storage, one example logical organization groups memory cells by banks and rows. For non-volatile storage, one example logical organization includes grouping cells into planes, sub-blocks, blocks, or pages.

The memory system 410 can include a memory system controller 412 with processor 426 and local memory 428. Memory system controller 412 can communicate with the memory modules 416A to 416N to perform operations such as reading data, writing data, or erasing data at the memory modules 416A to 416N and other such operations. The memory system controller 412 can include hardware such as one or more integrated circuits and/or discrete components, a buffer memory, or a combination thereof. The memory system controller 412 can be a microcontroller, special purpose logic circuitry (e.g., a field programmable gate array (FPGA), an application specific integrated circuit (ASIC), etc.), or other suitable processor. The memory system controller 412 can include a processor 426 (processing device) configured to execute instructions stored in a local memory. In the illustrated example, the local memory of the memory system controller 412 can include embedded memory 428 configured to store instructions for performing various processes, operations, logic flows, and routines that control operation of the memory system 410, including handling communications between the memory system 410 and the processor 414. In some embodiments, the local memory of the memory system controller 412 can include memory registers storing, e.g., memory pointers, fetched data, etc. The local memory can also include read-only memory (ROM) for storing micro-code.

In general, the memory system controller 412 can receive commands or operations from the processor 414 (or other component of a host) and can convert the commands or operations into instructions or appropriate commands to achieve the desired access to the memory modules 416A to 416N. The memory system controller 412 can be responsible for other operations such as wear leveling operations (e.g., garbage collection operations, reclamation), error detection and error-correcting code (ECC) operations, encryption operations, caching operations, block retirement, and address translations between a logical block address and a physical block address that are associated with the memory modules 416A to 416N. The memory system controller 412 can further include interface circuitry to communicate with the processor via the first interface 413. The interface circuitry can convert the commands received from the processor 414 into command instructions to access the memory modules 416A to 416N as well as convert responses associated with the memory modules 416A to 416N into information for the processor 414 or other component of the host system.

The memory system controller 412 can include a set of management tables to maintain various information associated with one or more components of the memory system 410. For example, the management tables can include indirection tables and other information regarding block age, block erase count, error history, or one or more error counts (e.g., a write operation error count, a read bit error count, a read operation error count, an erase error count, etc.) for one or more blocks of memory cells coupled to the memory system controller 412. The memory system controller 412, in conjunction with the compression component 424 may perform the operations of FIG. 3.

Memory system controller 412 can include a compression component 424. In some examples, the compression component 424 can be implemented by the media controller 420. In some examples, compression component 424 can be implemented by the memory system controller 412. In some examples, the functions of media controller 420 can be performed by the memory system controller 412. Compression component 424 can compress memory written to the memory array 422 using one or more compression algorithms, such as LZA.

Memory modules 416A-416N can include a media controller 420 that can communicate with the memory modules 416A to 416N to receive commands from the memory system controller 412 and to perform operations such as reading data, writing data, or erasing data from the memory array 422. For example, the media controller 420 can parse a command and determine the affected memory cells from the memory array 422 and can read and/or write a desired value to those memory cells. Media controller 420 can be responsible for refreshing or otherwise maintaining the data stored in the memory array 422.

The media controller 420 can include hardware such as one or more integrated circuits and/or discrete components, a buffer memory, or a combination thereof. The media controller 420 can be a microcontroller, special purpose logic circuitry (e.g., a field programmable gate array (FPGA), an application specific integrated circuit (ASIC), etc.), or other suitable processor(s). The media controller 420 can include a processor (processing device) configured to execute instructions stored in a local memory. In the illustrated example, the local memory of the media controller 420 can include embedded memory configured to store instructions for performing various processes, operations, logic flows, and routines that control the memory array 422, including handling communications between the memory module 416A-416N and the memory system controller 412. In some embodiments, the local memory of the media controller 420 can include memory registers storing, e.g., memory pointers, fetched data, etc. The local memory can also include read-only memory (ROM) for storing micro-code. Media controller 420 can also include address circuitry, row decoders, I/O circuitry write circuitry, column decoders, sensing circuitry, and other latches for decoding addresses, writing to, and reading from the memory array 422.

Processor 414, as well as memory system 410 can be integrated into a host system. The host system can be a computing device such as a desktop computer, laptop computer, network server, mobile device, or such computing device that includes a memory and a processing device. The host system and/or the memory system 410 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the processor 414 and to the memory system 410 so that the host system can read data from or write data to the memory system 410. As used herein, “coupled to” generally refers to a connection between components, which can be an indirect communicative connection or direct communicative connection (e.g., without intervening components), whether wired or wireless, including connections such as, electrical, optical, magnetic, and the like.

In an example, the memory system 410 can be a discrete memory and/or storage device component of a host system. In other examples, the memory system 410 can be a portion of an integrated circuit (e.g., system on a chip (SOC), etc.), stacked or otherwise included with one or more other components of a host system.

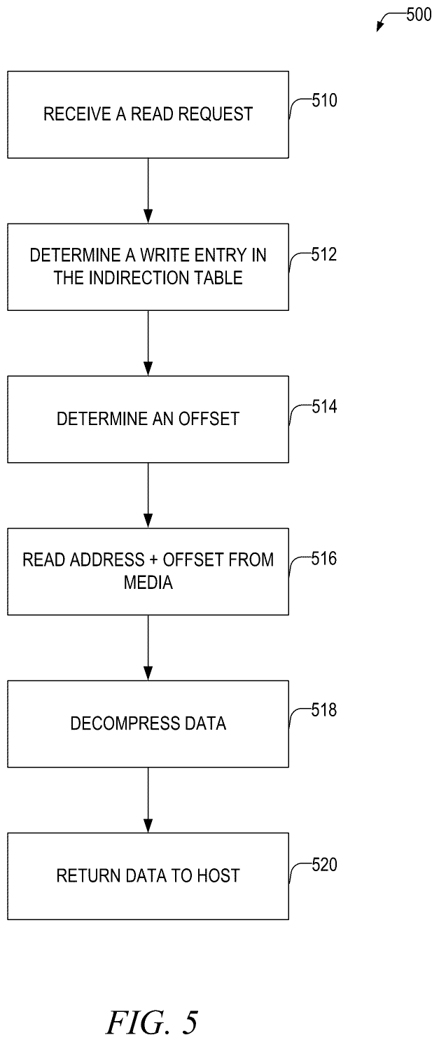

FIG. 5 shows a flowchart of a method 500 for reading compressed data using an indirection table according to some examples of the present disclosure. At step 510, the method begins with receiving a read request. This step involves the memory system obtaining a request from the host system to read specific data stored in the memory device. The read request may include an address of the data. At step 512, the method proceeds to determine a write entry in the indirection table. This step involves identifying the entry in the indirection table that corresponds to the write block containing the requested data. The indirection table maintains records of the starting addresses and offsets for each write block. The entry may be identified by the address provided in the read request 510 matching the address of the write block.

At step 514, the method determines an offset. This step involves calculating the offset within the write block where the specific compressed sub-block containing the requested data is located. The offset is used to pinpoint the exact location of the compressed data within the write block. At step 516, the method reads the address and offset from the media. This step involves accessing the memory media to retrieve the compressed data from the calculated address and offset. The memory system reads the data from the specified location in the memory cells. At step 518, the method decompresses the data. This step involves applying a decompression algorithm to the retrieved compressed data to restore the data to the original uncompressed form. The decompression process ensures that the data is in a usable state for the host system. At step 520, the method returns the data to the host. This step involves sending the decompressed data back to the host system, completing the read operation. The host system can then use the data as required for the host system operations.

As noted, in some examples, the indirection table may be adaptable based on the compression entropy of the data. Compression entropy refers to the measure of randomness or unpredictability in a dataset, which affects how well the data can be compressed. Data with stable compression entropy tends to have consistent compressibility characteristics over time, making it more predictable and easier to manage. For such data, the indirection table can manage larger blocks of data, further minimizing the number of entries required. This adaptability allows the indirection table to optimize memory space by using larger indirection block sizes for cold data, which is less frequently accessed and has more stable compression characteristics. By reducing the number of entries and optimizing the mapping of compressed data blocks, the new indirection table enhances the efficiency and performance of the memory management system, making it more suitable for environments with diverse and demanding data access patterns.

For example, the system may determine the compression entropy of the write data. If the probability that the compressed size will change above a first threshold is below a second threshold, the system uses a larger indirection entry size for the write data. This approach is based on the understanding that data with lower entropy changes less frequently, allowing for larger indirection blocks without significant performance degradation. Conversely, for data with a higher probability of the compressed size changing above the first threshold, a smaller indirection entry size is used to accommodate the more frequent changes in compressibility. This method optimizes memory space and improves the overall efficiency of the memory management system.

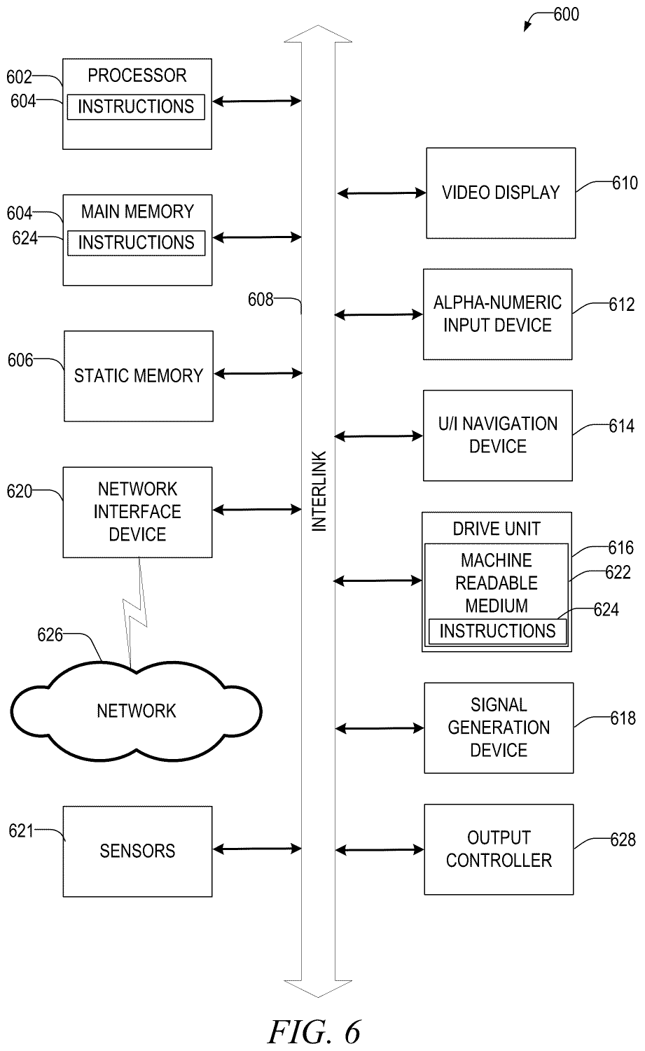

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be in the form of a computing system, server device, personal computer (PC), a tablet PC, a set-top box (STB), a personal digital assistant (PDA), memory device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In some examples, one or more of the components of FIG. 6 may be configured to perform the compression diagrammed in FIGS. 1, 2; the method of FIGS. 3 and 5; be or be configured as, the computing environment 400, the memory system 410, memory controller 412, memory modules 416A-N; or the like.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### Other Notes and Examples

Example 1 is a method of compressing data in a memory device, the method comprising: receiving write data; splitting the write data into a plurality of sub-blocks, each sub-block having a size corresponding to a compression block size; compressing each of the plurality of sub-blocks to produce a plurality of compressed sub-blocks, wherein a size of each of the plurality of compressed sub-blocks varies based upon the compressibility of the data in the sub-blocks prior to compression; writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and adding padding at the end of the write block.

In Example 2, the subject matter of Example 1 includes, maintaining an indirection table to manage a mapping of the compressed sub-blocks within the write block, wherein the indirection table includes entries indicating a start of each write block and a location of each compressed sub-block within the plurality of sub-blocks.

In Example 3, the subject matter of Example 2 includes, receiving a read request for a specific data block, and retrieving the specific data block from the write block using the indirection table to locate the compressed sub-blocks.

In Example 4, the subject matter of Examples 2-3 includes, wherein the indirection table comprises a single entry for the write block, the single entry comprising an address of the start of the write block, and an offset for each sub-block indicating a position of each sub-block within the write block.

In Example 5, the subject matter of Examples 2-4 includes, determining whether the write data is cold or hot; responsive to determining that the data is cold data, using a larger indirection entry size for the write data than a sized that would be used for hot data.

In Example 6, the subject matter of Examples 2-5 includes, determining a compression entropy of the write data; responsive to determining that a probability of a compressed size changing above a first threshold is below a second threshold, using a larger indirection entry size for the write data than the size used for data with a higher probability of the compressed size changing above the first threshold.

In Example 7, the subject matter of Examples 1-6 includes, Bytes.

In Example 8, the subject matter of Examples 1-7 includes, wherein the padding is added only at the end of the write block.

Example 9 is a computing device for compressing data in a memory device, the computing device comprising: a hardware processor; a memory, the memory storing instructions, which when executed by the hardware processor cause the computing device to perform operations comprising: receiving write data; splitting the write data into a plurality of sub-blocks, each sub-block having a size corresponding to a compression block size; compressing each of the plurality of sub-blocks to produce a plurality of compressed sub-blocks, wherein a size of each of the plurality of compressed sub-blocks varies based upon the compressibility of the data in the sub-blocks prior to compression; writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and adding padding at the end of the write block.

In Example 10, the subject matter of Example 9 includes, wherein the operations further comprise: maintaining an indirection table to manage a mapping of the compressed sub-blocks within the write block, wherein the indirection table includes entries indicating a start of each write block and a location of each compressed sub-block within the plurality of sub-blocks.

In Example 11, the subject matter of Example 10 includes, wherein the operations further comprise: receiving a read request for a specific data block, and retrieving the specific data block from the write block using the indirection table to locate the compressed sub-blocks.

In Example 12, the subject matter of Examples 10-11 includes, wherein the indirection table comprises a single entry for the write block, the single entry comprising an address of the start of the write block, and an offset for each sub-block indicating a position of each sub-block within the write block.

In Example 13, the subject matter of Examples 10-12 includes, wherein the operations further comprise: determining whether the write data is cold or hot; responsive to determining that the data is cold data, using a larger indirection entry size for the write data than a size that would be used for hot data.

In Example 14, the subject matter of Examples 10-13 includes, wherein the operations further comprise: determining a compression entropy of the write data; responsive to determining that a probability of a compressed size changing above a first threshold is below a second threshold, using a larger indirection entry size for the write data than the size used for data with a higher probability of the compressed size changing above the first threshold.

In Example 15, the subject matter of Examples 9-14 includes, Bytes.

In Example 16, the subject matter of Examples 9-15 includes, wherein the padding is added only at the end of the write block.

Example 17 is a machine-readable medium, storing instructions for compressing data in a memory device, the instructions, which when executed, cause the machine to perform operations comprising: receiving write data; splitting the write data into a plurality of sub-blocks, each sub-block having a size corresponding to a compression block size; compressing each of the plurality of sub-blocks to produce a plurality of compressed sub-blocks, wherein a size of each of the plurality of compressed sub-blocks varies based upon the compressibility of the data in the sub-blocks prior to compression; writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and adding padding at the end of the write block.

In Example 18, the subject matter of Example 17 includes, wherein the operations further comprise: maintaining an indirection table to manage a mapping of the compressed sub-blocks within the write block, wherein the indirection table includes entries indicating a start of each write block and a location of each compressed sub-block within the plurality of sub-blocks.

In Example 19, the subject matter of Example 18 includes, wherein the operations further comprise: receiving a read request for a specific data block, and retrieving the specific data block from the write block using the indirection table to locate the compressed sub-blocks.

In Example 20, the subject matter of Examples 18-19 includes, wherein the indirection table comprises a single entry for the write block, the single entry comprising an address of the start of the write block, and an offset for each sub-block indicating a position of each sub-block within the write block.

In Example 21, the subject matter of Examples 18-20 includes, wherein the operations further comprise: determining whether the write data is cold or hot; responsive to determining that the data is cold data, using a larger indirection entry size for the write data than a size that would be used for hot data.

In Example 22, the subject matter of Examples 18-21 includes, wherein the operations further comprise: determining a compression entropy of the write data; responsive to determining that a probability of a compressed size changing above a first threshold is below a second threshold, using a larger indirection entry size for the write data than the size used for data with a higher probability of the compressed size changing above the first threshold.

In Example 23, the subject matter of Examples 17-22 includes, Bytes.

In Example 24, the subject matter of Examples 17-23 includes, wherein the padding is added only at the end of the write block.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

What is claimed is:

1. A method of compressing data in a memory device, the method comprising:
receiving write data;
splitting the write data into a plurality of sub-blocks, each sub-block having a size corresponding to a compression block size;
compressing each of the plurality of sub-blocks to produce a plurality of compressed sub-blocks, wherein a size of each of the plurality of compressed sub-blocks varies based upon the compressibility of the data in the sub-blocks prior to compression;
writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and
adding padding at the end of the write block.

2. The method of claim 1, further comprising:
maintaining an indirection table to manage a mapping of the compressed sub-blocks within the write block, wherein the indirection table includes entries indicating a start of each write block and a location of each compressed sub-block within the plurality of sub-blocks.

3. The method of claim 2, further comprising:
receiving a read request for a specific data block, and
retrieving the specific data block from the write block using the indirection table to locate the compressed sub-blocks.

4. The method of claim 2, wherein the indirection table comprises a single entry for the write block, the single entry comprising an address of the start of the write block, and an offset for each sub-block indicating a position of each sub-block within the write block.

5. The method of claim 2, further comprising:
determining whether the write data is cold or hot;
responsive to determining that the data is cold data, using a larger indirection entry size for the write data than a sized that would be used for hot data.

6. The method of claim 2, further comprising:
determining a compression entropy of the write data;
responsive to determining that a probability of a compressed size changing above a first threshold is below a second threshold, using a larger indirection entry size for the write data than the size used for data with a higher probability of the compressed size changing above the first threshold.

7. The method of claim 1, wherein a size of the write block is 4 KB, the compression block size is 64 Bytes, and a size of the sub-blocks are 64 Bytes.

8. The method of claim 1, wherein the padding is added only at the end of the write block.

9. A computing device for compressing data in a memory device, the computing device comprising:
a hardware processor;
a memory, the memory storing instructions, which when executed by the hardware processor cause the computing device to perform operations comprising:
receiving write data;
splitting the write data into a plurality of sub-blocks, each sub-block having a size corresponding to a compression block size;
compressing each of the plurality of sub-blocks to produce a plurality of compressed sub-blocks, wherein a size of each of the plurality of compressed sub-blocks varies based upon the compressibility of the data in the sub-blocks prior to compression;
writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and
adding padding at the end of the write block.

10. The computing device of claim 9, wherein the operations further comprise:
maintaining an indirection table to manage a mapping of the compressed sub-blocks within the write block, wherein the indirection table includes entries indicating a start of each write block and a location of each compressed sub-block within the plurality of sub-blocks.

11. The computing device of claim 10, wherein the operations further comprise:
receiving a read request for a specific data block, and
retrieving the specific data block from the write block using the indirection table to locate the compressed sub-blocks.

12. The computing device of claim 10, wherein the indirection table comprises a single entry for the write block, the single entry comprising an address of the start of the write block, and an offset for each sub-block indicating a position of each sub-block within the write block.

13. The computing device of claim 10, wherein the operations further comprise:
determining whether the write data is cold or hot;
responsive to determining that the data is cold data, using a larger indirection entry size for the write data than a size that would be used for hot data.

14. The computing device of claim 10, wherein the operations further comprise:
determining a compression entropy of the write data;
responsive to determining that a probability of a compressed size changing above a first threshold is below a second threshold, using a larger indirection entry size for the write data than the size used for data with a higher probability of the compressed size changing above the first threshold.

15. The computing device of claim 9, wherein a size of the write block is 4 KB, the compression block size is 64 Bytes, and a size of the sub-blocks are 64 Bytes.

16. The computing device of claim 9, wherein the padding is added only at the end of the write block.

17. A machine-readable medium, storing instructions for compressing data in a memory device, the instructions, which when executed, cause the machine to perform operations comprising:
receiving write data;
splitting the write data into a plurality of sub-blocks, each sub-block having a size corresponding to a compression block size;
compressing each of the plurality of sub-blocks to produce a plurality of compressed sub-blocks, wherein a size of each of the plurality of compressed sub-blocks varies based upon the compressibility of the data in the sub-blocks prior to compression;
writing the plurality of compressed sub-blocks into a write block of memory cells, the write block of memory cells comprising a plurality of smaller sub-blocks, wherein at least one of the plurality of compressed sub-blocks is written partially within one of the plurality of sub-blocks and partially within a next one of the plurality of sub-blocks; and
adding padding at the end of the write block.

18. The machine-readable medium of claim 17, wherein the operations further comprise:
maintaining an indirection table to manage a mapping of the compressed sub-blocks within the write block, wherein the indirection table includes entries indicating a start of each write block and a location of each compressed sub-block within the plurality of sub-blocks.

19. The machine-readable medium of claim 18, wherein the operations further comprise:
receiving a read request for a specific data block, and
retrieving the specific data block from the write block using the indirection table to locate the compressed sub-blocks.

20. The machine-readable medium of claim 18, wherein the indirection table comprises a single entry for the write block, the single entry comprising an address of the start of the write block, and an offset for each sub-block indicating a position of each sub-block within the write block.
